(19) United States
(12) Patent Application Publication
(10) Pub. No.: US 2016/0244344 A1
(43) Pub. Date: Aug. 25, 2016

(54) APPARATUS AND SYSTEM FOR TREATING ACID MINE DRAINAGE USING ELECTROCHEMICAL REACTION

(71) Applicant: KOREA INSTITUTE OF GEOSCIENCE AND MINERAL RESOURCES (KIGAM), Daejeon (KR)

(72) Inventors: Sang-min PARK, Jeonju-si (KR); Sang-woo JI, Daejeon (KR); Kitae BAEK, Jeonju-si (KR); Chamteut OH, Seoul (KR); Gil-jae YIM, Daejeon (KR); Young-wook CHEONG, Daejeon (KR)

(21) Appl. No.: 15/052,136

(22) Filed: Feb. 24, 2016

(30) Foreign Application Priority Data
Feb. 25, 2015 (KR) 10-2015-0026412

(51) Int. Cl. C02F 1/461; C21B 15/00; C22B 61/00

(52) U.S. Cl. CPC C02F 1/46104; C22B 61/00; C21B 15/00

(57) ABSTRACT

The present invention relates to an apparatus and a system for treating acid mine drainage. The apparatus includes first and second reaction baths for receiving acid mine drainage, wherein the first and second reaction baths are provided with inlets and outlets and are separated from each other to prevent communication between acid mine drainages, an electrically connected anode and a cathode installed in each of the first and second reaction baths, and an electron transport medium for connecting the first reaction bath receiving the anode and the second reaction bath receiving the cathode. The electron transport medium blocks the transport of metal cations and allows the transport of electrons between acid mine drainages in the first and second reaction baths. Ferrous ions are oxidized to ferric ions in the acid mine drainage to precipitate hydroxides in the first reaction bath, and hydroxide ions are produced in the second reaction bath.

### BACKGROUND OF THE INVENTION

1. Field of the Invention

The present invention relates to a system and a method for treating acid mine discharged from an exhausted mine or a dormant mine, and more particularly, to an apparatus and a system for neutralizing acid mine drainage and removing heavy metals using electrochemical reaction.

2. Description of the Related Art

Environmental contamination generated from an exhausted mine or a dormant mine may include ground subsidence, the burial of a river due to the loss of waste rocks and mine dumps, the soil contamination due to heavy metals, and water pollution due to minehead outflow and waste rock leachate. Particularly, the water pollution due to acid mine drainage from an underground waste ore pile causes serious issues.

Purification methods of the acid mine drainage may be classified as a passive treatment and an active treatment.

The passive treatment includes neutralization methods using limestone such as anoxic limestone drains (ALDs) and oxic limestone drains (OLD), aerobic and anaerobic artificial bogs, successive alkalinity-producing systems (SAPS), RAPS, or the like. The passive treatment is composed of a system for naturally treating acid mine drainage by installing a neutralizing layer such as limestone and an organic layer including microorganisms capable of reducing sulfates, and by passing the acid mine drainage therethrough. The passive treatment is economic and has merits of operating the system without inputting energy or manpower separately. However, frequently, iron or heavy metals discharged from the acid mine drainage may be deposited on the neutralizing layer to deteriorate easy draining, or the limestone may be coated to inhibit neutralization.

The active treatment may include pH control using a neutralizing agent, electrochemical reaction, coagulation, filtration, or the like. According to the active treatment, apparatuses, chemicals, manpower, or dynamic forces are required to be continuously injected, and economic feasibility for the maintenance and management thereof is inferior to the passive treatment. However, treatment efficiency is good and is rather preferable in consideration of the decreasing efficiency of environmental contamination.

A method of using electrochemical reaction as one of the active treatment (Korean Patent Registration No. 10-0893338) is a technique of neutralizing acid mine drainage by alternately disposing cathode plates 4 and anode plates 5 in a reaction bath 1 receiving acid mine drainage as shown in FIG. 1, and supplying a power source to oxidize ferrous ions to ferric ions in the acid mine drainage so as to precipitate hydroxides and neutralize the acid mine drainage. However, ferric hydroxide produced in the reaction bath according to the lapse of time may attach to the surface of the cathode plate, and electrolysis may not be smoothly performed according to the above-described treatment system. In the system shown in FIG. 1, scrapers 6 capable of removing the ferric hydroxide from the surface of the cathode plate 4 may be installed to solve the above-described defects. However, the installation of the scrapers made the system complicated, the ferric hydroxide was not removed completely, and the operation of the whole system became impossible.

Meanwhile, the acid mine drainage has been treated passively and mainly for preventing water pollution and soil contamination, and active efforts for industrial recycling of the acid mine drainage has not been performed domestically.

In the acid mine drainage, a large amount of useful metals for industrial use such as iron, aluminum, manganese, copper and zinc are dissolved. However, the metals are mixed heterogeneously in various types, and some metals have similar physical and chemical behavior. However, the selective recovery of each metal is not easy, and all the metals have been discarded.

Accordingly, active utilization of exhausted mines for the selective recovery of each metal from acid mine drainage via technical development is required. In addition, developments on a technique of economic purification without causing purification treatment, by which a recovering method of useful metals from the acid mine drainage is performed separately from the common passive treatment of the acid mine drainage, are required.

### SUMMARY OF THE INVENTION

Accordingly, the present invention is directed to provide an apparatus for treating acid mine drainage having an improved structure, by which the acid mine drainage may be neutralized using electrochemical reaction, and electrolysis reaction may be continuously and smoothly conducted, so as to substantially obviate the limitations of the related art.

Another object of the present invention is to provide a system for treating for separating and recovering useful metals from acid mine drainage by using a neutralizing solution obtained from electrolysis.

To achieve these objects and other advantages, there is provided an apparatus for treating acid mine drainage including a first reaction bath and a second reaction bath, in which inlets and outlets of the acid mine drainage are provided, and wherein the first reaction bath and the second reaction bath receive the acid mine drainage and are separated from each other to prevent the communication between the acid mine drainages; an anode and a cathode, which are installed in each of the first reaction bath and the second reaction bath, and which are electrically connected; and an electron transport medium for connecting the first reaction bath receiving the anode and the second reaction bath receiving the cathode, wherein the electron transport medium blocks the transport of metal cations and allows the transport of electrons between the acid mine drainages received in the first reaction bath and the second reaction bath. Ferrous ions are oxidized to ferric ions in the acid mine drainage to precipitate hydroxides in the first reaction bath, and hydroxide ions are produced in the second reaction bath.

According to the present invention, the electron transport medium may include a connecting pipe for connecting the first reaction bath and the second reaction bath, and a membrane installed so as to block the flow path in the connecting pipe and to transport only electrons. Particularly, the membrane may be a gore-tex material or an anionic film for selectively penetrating only electrons and anions.

Preferably, the electron transport medium may be a salt bridge of which terminals are connected to each of the first reaction bath and the second reaction bath.

Meanwhile, according to another aspect of the present invention, a system for treating acid mine drainage includes an electrochemical reaction bath having the same configuration as the above-described treating apparatus; and a precipitation bath for receiving the acid mine drainage discharged from the first reaction bath and the aqueous solution discharged from the second reaction bath, controlling pH, and precipitating and recovering useful metals from the acid mine drainage, wherein the amount of the aqueous solution inflowing from the second reaction bath to the precipitation bath is controlled to control the pH of the precipitation bath.

In addition, the system may further include a circulating pipe for connecting the precipitation bath and the second reaction bath for inflowing the acid mine drainage from the precipitation bath to the second reaction bath.

In an embodiment of the present invention, a plurality of the precipitation baths may be installed to make inter-communication one by one, the acid mine drainage from the first reaction bath may be transported via the plurality of precipitation baths one by one, and the acid mine drainage in respective precipitation bath may be formed to have a different pH range to precipitate different useful metals in each precipitation bath.

Particularly, the system may further include an injecting pipe for interconnecting the second reaction bath and the plurality of precipitation baths to inject the aqueous solution in the second reaction bath to the plurality of the precipitation baths, and pH of each acid mine drainage in the plurality of the precipitation baths may be formed to have a different range by controlling the amount of the aqueous solution from the second reaction bath to each of the plurality of the precipitation baths. For this, the system may further include a pH sensor provided in the precipitation bath for measuring the pH of the acid mine drainage.

In an embodiment of the present invention, a mixing part may be formed in the precipitation bath so that the acid mine drainage discharged from the first reaction bath and the aqueous solution discharged from the second reaction bath may inflow to the precipitation bath in a mixture state, and a supplying pipe connected with the first reaction bath and an injecting pipe connected from the second reaction bath may preferably be connected to the mixture part.

By the treating system 200 using the treating apparatus of acid mine drainage (electrochemical reaction bath) 100 according to the present invention, the acid mine drainage may be neutralized and useful metals may be selectively recovered simultaneously. Accordingly, the treating system may be applied to both environmental treatment and industrial usage.

In addition, according to the present invention, defects of deactivation due to the coating of the electrode in a conventional electrochemical method may be solved, and the deactivation of an electrode may not arise for a long time, and the maintenance and management thereof may be easy.

### BRIEF DESCRIPTION OF THE DRAWINGS

FIG. 1 is a schematic diagram of an apparatus for treating acid mine drainage using electrochemical reaction disclosed in Korean Patent Registration No. 10-0893338;

FIG. 2 is a schematic configuration diagram of an apparatus for treating acid mine drainage using a salt bridge according to an embodiment of the present invention;

FIG. 3 is a schematic diagram of an apparatus for treating acid mine drainage using a membrane according to another embodiment of the present invention;

FIG. 4 is a photographic diagram of an apparatus for treating acid mine drainage shown in FIG. 3;

FIG. 5 is a schematic configuration diagram of a system for treating acid mine drainage according to an embodiment of the present invention;

FIG. 6 is a graph showing pH and ORP changes according to the lapse of time in a second reaction bath in an apparatus for treating acid mine drainage using a salt bridge as an electron exchange medium;

FIG. 7 is a graph showing iron concentration changes according to the lapse of time in a first reaction bath in an apparatus for treating acid mine drainage using a salt bridge as an electron exchange medium; and

FIG. 8 is a graph showing iron concentration changes in case where hydrogen peroxide is used.

### DETAILED DESCRIPTION OF THE INVENTION

Referring to the accompanying drawings, the apparatus and the system for treating acid mine drainage according to an embodiment of the present invention will be explained in more detail.

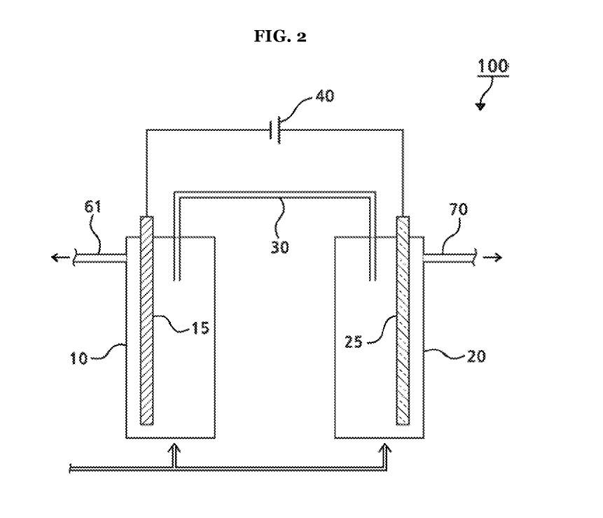

FIG. 2 is a schematic configuration diagram of an apparatus for treating acid mine drainage using a salt bridge according to an embodiment of the present invention.

Referring to FIG. 2, an apparatus 100 for treating acid mine drainage according to an embodiment of the present invention is provided with a first reaction bath 10, a second reaction bath 20, an anode 15, a cathode 25 and a salt bridge 30 used as an electron transport medium.

The first reaction bath 10 is for receiving acid mine drainage, and an inlet 11 for inflowing the acid mine drainage is formed at the bottom portion thereof and an outlet 12 for discharging the acid mine drainage is formed at the top portion thereof.

The second reaction bath 20 receives an aqueous solution or acid mine drainage and is provided with an inlet 21 for inflowing the aqueous solution or the acid mine drainage and an outlet 22, respectively at the top portion and the bottom portion thereof as in the first reaction bath. The first reaction bath 10 and the second reaction bath 20 are separated from each other, and the acid mine drainage or the aqueous solution received in the reaction baths do not inter-communicate from each other. In each of the first reaction bath 10 and the second reaction bath 20, a stirrer 51 or 52 is installed to stir the acid mine drainage or the aqueous solution.

In the first reaction bath 10, an anode 15 connected with the positive electrode of a power source 40 is installed, and in the second reaction bath 20, a cathode 25 connected with the negative electrode of the power source 40 is installed in the second reaction bath, and the anode 15 and the cathode 25 are electrically interconnected.

In addition, the salt bridge 30 is an electron transport medium for transporting electrons generated from the acid mine drainage in the first reaction bath 10 to the acid mine drainage or the aqueous solution in the second reaction bath 20, and of which one end is installed in the first reaction bath 10 and of which another end is installed in the second reaction bath 20.

The apparatus 100 for treating acid mine drainage having the above-described configuration performs the treatment of the acid mine drainage via electrochemical reaction. That is, when a power source 40 is on, ferrous ions are converted into ferric ions to produce electrons around the anode 15 in the first reaction bath 10 as the following Formula (1), and the ferric ions react with OH⁻ in the acid mine drainage to form iron hydroxide such as iron (III) hydroxide (Fe(OH)₃).

Fe²⁺(aq)→Fe³⁺(aq)+2e⁻ Formula (1)

In addition, water is hydrolyzed to produce hydroxide ions and hydrogen around the cathode 25 in the second reaction bath 20 as the following Formula (2).

2H⁺(aq)+2e⁻→H₂(g)

2H₂O+2e⁻→H₂(g)+2OH⁻(aq) Formula (2)

Since the salt bridge 30 may transport electrons, electrons may allow electron transport medium between the first reaction bath and the second reaction bath via the salt bridge with the application of power. In the result, the ferrous ions are precipitated to the iron hydroxide in the acid mine drainage, and heavy metals in the acid mine drainage may be removed in the first reaction bath 10, and the hydroxide ions are produced in the second reaction bath 20 to increase the pH of the acid mine drainage or the aqueous solution in the second reaction bath 20.

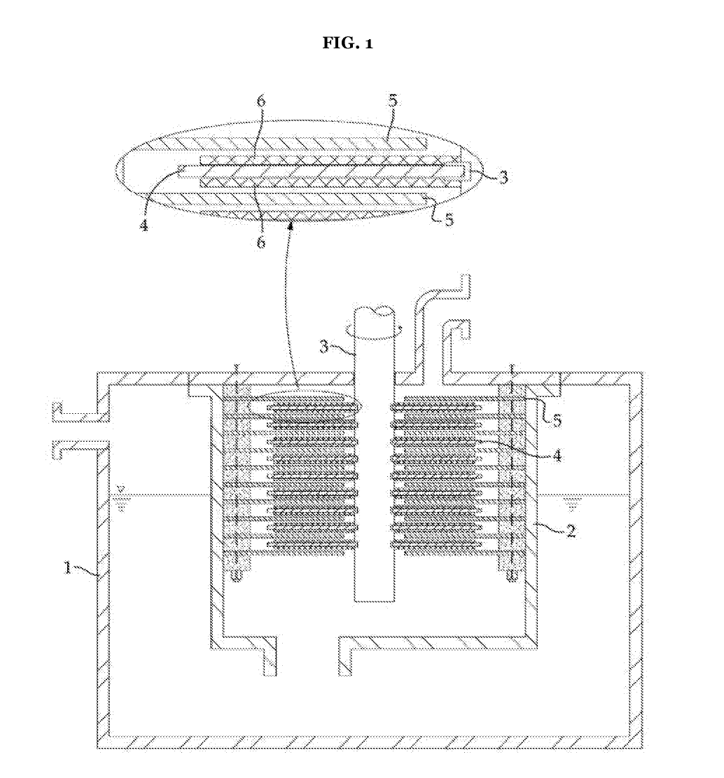

The principle of the electrolysis as described above is the same as that of a common method introduced in an electrochemical treatment of acid mine drainage. However, the present invention is different from the common method in that the first reaction bath and the second reaction bath are separated from each other, and only electrons may transport between the reaction baths. In the conventional electrolysis bath shown in FIG. 1, cathodes and anodes are installed in one reaction bath, and iron precipitates are attached to the cathodes to form a coat. In this case, the cathodes may not perform the function as electrodes. However, in the present invention, the anode and the cathode are separated from each other, and the transport of cationic metal ions such as ferrous ions or ferric ions from the first reaction bath may be restrained, and the transport of electrons produced from the first reaction bath may be allowed. Accordingly, the electrolysis may be performed smoothly, and the coating of the cathode with the precipitate may be prevented. Since the cathode may always maintain an active state, the limitations of removing precipitates using a scraper or cleaning water with high pressure from the surface of the cathode as in the conventional technique may be solved.

It should be noted that only the acid mine drainage is fed to the first reaction bath 10, and the acid mine drainage or the aqueous solution is fed to the second reaction bath 20.

In the case where the acid mine drainage is fed to both the first reaction bath 10 and the second reaction bath 20, the ferrous ions may be removed from, however neutralization may not be performed in the acid mine drainage fed to the first reaction bath 10, and neutralization may be performed in, however the removal of iron may not be performed from the second reaction bath 20. For treating the acid mine drainage, the removal of the iron and the neutralization should be performed at the same time. Accordingly, the acid mine drainage is first fed to the first reaction bath 10 and the second reaction bath 20 for treatment, and then, the two treated products are mixed and fed to the first reaction bath and the second bath again. Through repeating the cycle, the iron may be removed from the acid mine drainage, and the neutralization may be performed when taking as a whole.

Alternatively, in the case where the acid mine drainage is fed to the first reaction bath 10, and an uncontaminated aqueous solution such as water is fed to the second reaction bath, the acid mine drainage from which iron is removed in the first reaction bath 10 and the aqueous solution including the hydroxide ions in the second reaction bath 20 are mixed and discharged to perform the removal of the iron from the acid mine drainage and the neutralization at the same time.

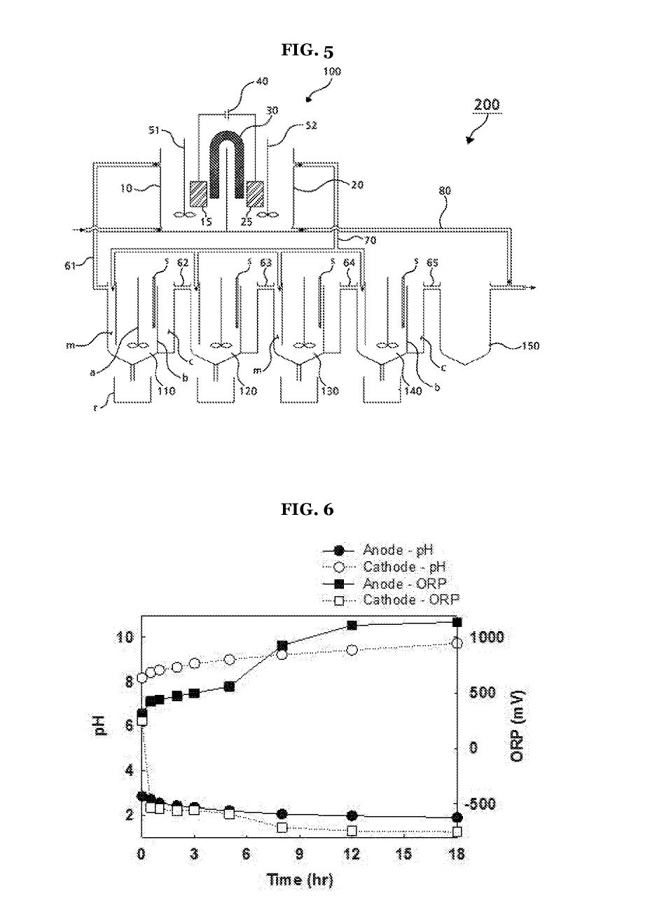

In the present invention, a system 200 for treating acid mine drainage is developed to more actively use the apparatus 100 for treating acid mine drainage as described above. FIG. 5 is a schematic configuration diagram of a system for treating acid mine drainage according to an embodiment of the present invention. The system for treating acid mine drainage according to the present invention is departed from passive concept of environmental treating of the acid mine drainage, and introduces active concept of recovering useful metals from the acid mine drainage and performing neutralization simultaneously. Particularly, pH controlling solution is required for the recovery of the useful metals and the neutralization, and the apparatus 100 for treating acid mine drainage described above uses the aqueous solution in the second reaction bath 20 as a pH controlling solution.

Referring to accompanying drawings, the configuration of the system 200 for treating acid mine drainage according to the present invention will be explained, and then, the method of recovering useful metals and neutralization will be additionally explained.

Referring to FIG. 5, the system 200 for treating acid mine drainage according to an embodiment of the present invention is provided with at least one precipitation bath together with the apparatus 100 for treating acid mine drainage having the above-described configuration as an electrochemical reaction bath. In this embodiment, four precipitation baths 110, 120, 130 and 140 are installed.

As described above, the electrochemical reaction bath is provided with a first reaction bath 10, a second reaction bath 20, an anode 15, a cathode 25, and an electron transport medium (for example, salt bridge). To the first reaction bath 10, acid mine drainage is fed, and ferrous ions are oxidized to ferric ions and to precipitate hydroxides while producing electrons. In the second reaction bath 20, an aqueous solution is decomposed to produce hydroxide ions.

A plurality of precipitation baths 110, 120, 130 and 140 are arranged in a row, and the top portion of the first precipitation bath 110 disposed in the first position and the top portion of the first reaction bath 10 are interconnected via a supplying pipe 61, and acid mine drainage is supplied from the first reaction bath 10. In addition, supplying pipes 62, 63 and 64 are continuously connected with the upper portions of the second precipitation bath 120, the third precipitation bath 130 and the fourth precipitation bath 140, respectively. The finally positioned fourth precipitation bath 140 is provided with an outlet 65 for discharging the thus treated acid mine drainage. A circulating pipe 80 branched from the outlet 65 and connected with the second reaction bath 20 is provided.

The acid mine drainage supplied from the first reaction bath 10 is treated each process such as a recovering process of useful metals and a neutralizing process while passing through the first precipitation bath 110 to the fourth precipitating bath 140, and is finally discharged via the outlet 65.

The injecting pipe 70 provided at the top portion of the second reaction bath 20 is separated into a plurality of branch pipes and connected to each of the precipitation baths 110, 120, 130 and 140. The aqueous solution (or acid mine drainage, hereinafter will be referred to as “pH controlling solution”) discharged from the second reaction bath 20 includes hydroxide ions, has a high pH value, and may control the pH of the acid mine drainage in each of the precipitation baths according to the injecting amount to each precipitation bath. For that, a valve for controlling flowing amount or a flowing amount controller (not shown) may be installed to each branch pipe from the injecting pipe 70 to respective precipitation bath in an embodiment. In addition, a pH sensor s is installed in each precipitation bath for monitoring the pH of the acid mine drainage received therein.

As described above, to each of the precipitation baths 110, 120, 130 and 140, the acid mine drainage started from the first reaction bath 10 and the pH controlling solution supplied from the second reaction bath 20 are fed. In order to feed the liquids to each precipitate bath as a mixture state or in order to mix the liquids rapidly in the precipitation bath, a mixing part m is provided in each precipitation bath. The mixing part m is formed at one side of the precipitation bath as a long column shape along an up and down direction, and the supplying pipes 61, 62, 63 and 64, and an injecting pipe 70 are connected to the upper portion of the mixing part m. The acid mine drainage and the pH controlling solution injected via the upper portion of the mixing part m are mixed in the mixing part m and then injected to the precipitation bath via the lower portion thereof. Rotatable stirrers a are installed in the precipitation baths 110, 120, 130 and 140 for the well-mixing of the pH controlling solution and the acid mine drainage.

In addition, a collecting part c is provided in each precipitation bath to collect supernatant at the upper portion and discharge to a next precipitation bath. For example, the acid mine drainage treated in the first precipitation bath 110 is transported to the second precipitation bath 120, wherein the supernatant is collected in the collecting part c in the first precipitation bath 110, and the acid mine drainage collected in the collecting part c is transported to the second precipitation bath 120. The collecting part c is disposed at the opposite side of the mixing part m as a long column shape in an up and down direction. When the acid mine drainage and the pH controlling solution are fed via the bottom portion of the precipitation bath, the supernatant passes over a partition b to the collecting part c. At last, the supplying pipes 62, 63 and 64 between the precipitation baths are connected from the collecting part c to the mixing part m.

At the bottom portion of each precipitation bath, a recovering part r connected via a pipe is provided, and precipitated useful metals precipitated at the bottom portion of the precipitation bath may be collected.

Meanwhile, the acid mine drainage passed through all of the plurality of the precipitation baths is collected in a discharging bath 150 and finally discharged. A portion of the acid mine drainage is fed to the second reaction bath 20 via a recovering pipe 80.

The neutralization of the acid mine drainage and the recovery of the useful metals by the system 200 for treating acid mine drainage according to the present invention and having the above-described configuration, will be explained.

The acid mine drainage is fed to the first reaction bath 10 while an aqueous solution is received in the second reaction bath 20. By the beginning of electrolysis with the application of power, ferrous ions are oxidized to ferric hydroxide as precipitate in the acid mine drainage in the first reaction bath 10, and hydroxide ions are produced in the aqueous solution to increase pH in the second reaction bath 20.

In order to examine the effect of the apparatus 100 for treating acid mine drainage (electrochemical reaction bath), acid mine drainage is fed to the first reaction bath, an aqueous solution is fed to the second reaction bath, and electrolysis is performed. The results are shown in FIGS. 6 to 8.

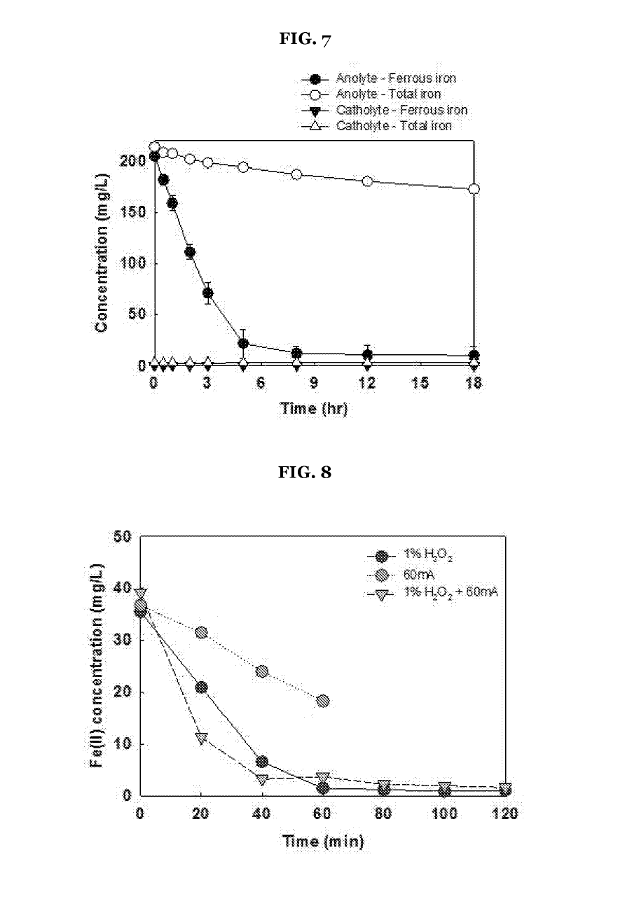

The graphs in FIGS. 6 and 7 show the concentration changes of iron (Fe²⁺) according to the lapse of time in a first reaction bath, and pH and ORP changes in a second reaction bath in an apparatus for treating acid mine drainage using a salt bridge as an electron exchange medium.

The pH in the first reaction bath in the experiment using U-shaped salt bridge began at 3 and decreased to 1.9 after 18 hours, and the pH in the second reaction bath began at 6 and increased to 9.8. The ORP gradually decreased in an anolyte and rapidly decreased for 30 minutes and then gradually decreased in a catholyte.

For the concentration change of Fe in the graph in FIG. 7, Fe was rarely present in the second reaction bath, and no change was shown after the lapse of time. Accordingly, it would be found that Fe was not transported from the first reaction bath to the second reaction bath via the salt bridge. In the first reaction bath, Fe was rapidly oxidized and precipitated, and the concentration of Fe in the acid mine drainage was rapidly decreased for 5 hours, and then, oxidation was gradually performed. In 8 hours from the start of the experiment, most of Fe was oxidized.

On the basis of the experimental results, it would be confirmed that by using the salt bridge as an electron exchange medium in electrochemical reaction, the pH in the second reaction bath was increased to about 10 while decreasing Fe in the acid mine drainage. Therefore, the aqueous solution in the second reaction bath may be used as a neutralizing agent for neutralizing acid mine drainage or as a pH controlling solution in a subsequent process.

Meanwhile, the electrode reaction rate may be slow, and the oxidation of iron may be slow even though using the salt bridge. In this case, sufficiently rapid reaction rate may be attained by adding a small amount of hydrogen peroxide. FIG. 8 is a graph obtained from experiments for comparison with or without 1% hydrogen peroxide in the first reaction bath. In a case where the hydrogen peroxide is added, it was confirmed that the oxidation of ferrous ions was mostly completed within 40 minutes.

As described above, the acid mine drainage of which most iron is removed in the first reaction bath of the apparatus 100 for treating acid mine drainage is fed to the first precipitation bath no and then is finally treated via the fourth precipitation bath 140.

In each precipitation bath, a pH controlling solution supplied from the second reaction bath is fed. The pH of the pH controlling solution is about 9-10.

The acid mine drainage discharged from the first reaction bath is formed in a pH range of about 2-4, and the pH thereof is increased through mixing with the pH controlling solution in the first precipitation bath. Through continuous passing from the second precipitation bath to the fourth precipitation bath, the pH is increased to a pH range of about 7-9, and the neutralization is completed. The control of the pH range in each precipitation bath may be changed according to the kind of a metal required to be recovered from the acid mine drainage. Each of various useful metals included in the acid mine drainage has different pH range for the precipitation as a hydroxide, and the metal may be selectively recovered by controlling the pH range. For example, iron may be precipitated as a hydroxide in a pH range of 3.5-4.5, aluminum may be precipitated as a hydroxide in a pH range of 4.5-5.5, copper may be precipitated in a pH range of 5.5-7, and manganese may be precipitated as a hydroxide in a pH range of 7.5-9.5. In the present invention, in the four precipitation baths of the first to fourth precipitation baths, iron, aluminum, copper and manganese may be recovered, respectively by precipitating as the hydroxides thereof.

According to the properties of the acid mine drainage, the kind of metals to be recovered may be different, and the number of the precipitation bath or the pH range of each precipitation bath may be controlled. The important thing is that useful metals may be selectively recovered in respective precipitation bath by supplying the pH controlling solution supplied from the second reaction bath to respective precipitation bath, and controlling the pH of respective precipitation bath. Since the pH of the finally discharged acid mine drainage after passing through all the precipitation baths is neutral, neutralization is also completed. In an embodiment, a discharging bath 150 may be further installed next to the fourth precipitation bath 140. The pH of the finally discharged acid mine drainage is measured, and in the case where the pH is not included in a reference value, a neutralizing agent may be further added to finally control the pH range.

The above processes are continuously performed. That is, new acid mine drainage is continuously fed to the first reaction bath 10 and discharged, and the second reaction bath is composed of a circulation system and circulates the treated acid mine drainage to reuse.

As described above, in the system 200 for treating using the apparatus 100 for treating acid mine drainage (electrochemical reaction bath), the neutralization of the acid mine drainage and the selective recovery of useful metals therefrom may be performed simultaneously, thereby being applied to both environmental treatment and industrial use.

In addition, defects of deactivation of an electrode due to coating in a conventional electrochemical method may be solved, and the activity of an electrode may be good for a long time and the maintenance and management thereof may be easy in the present invention.

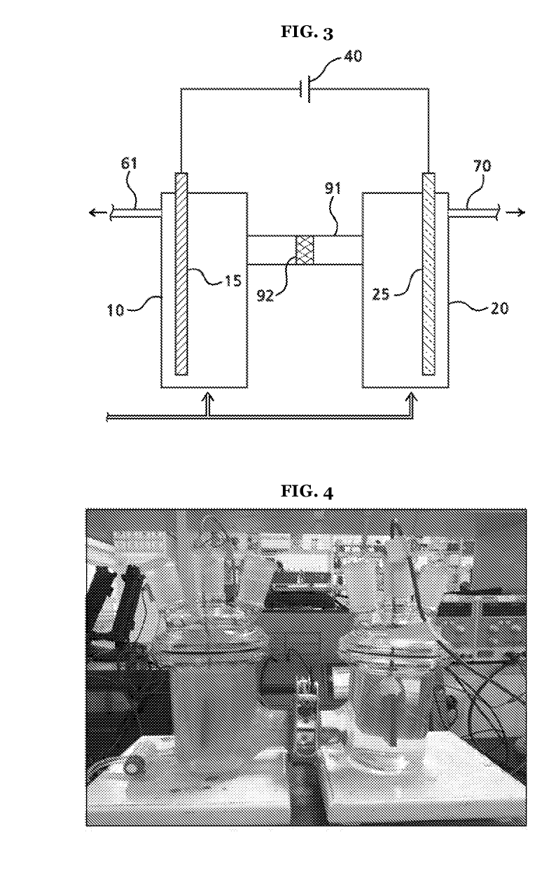

Until now, the apparatus for treating acid mine drainage according to the present invention has been explained and illustrated using a salt bridge as en electron exchange medium. The salt bridge is the most effective medium as the electron exchange medium, however a membrane may be also used as the electron transport medium in the present invention. In FIGS. 3 and 4, an example using a membrane is shown.

Referring to FIGS. 3 and 4, a connecting pipe 91 is formed between a first reaction bath 10 and a second reaction bath 20, and a membrane 92 is installed in the connecting pipe 91. Metal cations may not penetrate, but electrons or anions may penetrate the membrane 92. The material of the membrane may be gore-tex or an anionic film. An important thing is that cations such as ferrous ions and ferric ions may not penetrate the membrane. As described in the conventional technique, when metal cations are fed to the second reaction bath, the cations may attach to a cathode to deteriorate the activity thereof. According to the experiments by the present inventors, the membrane may be used as a medium for penetrating electrons, however impurities may attach to the membrane to deteriorate the flowability. Accordingly, the salt bridge is used as the most appropriate medium even though the membrane is not excluded as the electron transport medium in the present invention.

It will be apparent to those skilled in the art that various modifications and variations can be made in the present invention. Thus, it is intended that the present invention covers the modifications and variations of this invention provided they come within the scope of the appended claims and their equivalents.

### EXPLANATION ON REFERENCE SYMBOLS

100 . . . Apparatus for treating acid mine drainage (electrochemical reaction bath)
200 . . . System for treating acid mine drainage
10 . . . First reaction bath
20 . . . Second reaction bath
15 . . . Anode
25 . . . Cathode
30 . . . Salt bridge
40 . . . Power source
61, 62, 63, 64 . . . Supplying pipes
70 . . . Injecting pipe
80 . . . Circulating pipe
91 . . . Connecting pipe
92 . . . Membrane
110 . . . First precipitation bath
120 . . . Second precipitation bath
130 . . . Third precipitation bath
140 . . . Fourth precipitation bath
m . . . Mixing part
c . . . Collecting part
s . . . pH sensor

What is claimed is:

1. An apparatus for treating acid mine drainage, the apparatus comprising:
a first reaction bath and a second reaction bath, in which inlets and outlets of the acid mine drainage are provided, the first reaction bath and the second reaction bath receiving the acid mine drainage and being separated from each other to prevent the communication between the acid mine drainages;
an anode which is installed in the first reaction bath, and a cathode which is installed in the second reaction bath and electrically connected to the anode; and
an electron transport medium for connecting the first reaction bath receiving the anode and the second reaction bath receiving the cathode, the electron transport medium blocking the transport of metal cations and allowing the transport of electrons between the acid mine drainages received in the first reaction bath and the second reaction bath,
ferrous ions being oxidized to ferric ions in the acid mine drainage to precipitate hydroxides in the first reaction bath, and hydroxide ions being produced in the second reaction bath.

2. The apparatus for treating acid mine drainage of claim 1, wherein the electron transport medium comprises a connecting pipe for connecting the first reaction bath and the second reaction bath, and a membrane installed so as to block the flow path in the connecting pipe and to transport only electrons.

3. The apparatus for treating acid mine drainage of claim 2, wherein the membrane is a gore-tex material or an anionic film for selectively penetrating only electrons and anions.

4. The apparatus for treating acid mine drainage of claim 1, wherein the electron transport medium is a salt bridge of which terminals are connected to each of the first reaction bath and the second reaction bath.

5. The apparatus for treating acid mine drainage of claim 1, wherein the inlets are formed at the bottom portions, and the outlets are formed at the top portions of each of the first reaction bath and the second reaction bath, and the acid mine drainage make a passage of inflowing from the bottom portion and discharging to the top portion.

6. A system for treating acid mine drainage, the system comprising:
an electrochemical reaction bath comprising a first reaction bath provided with an anode and receiving acid mine drainage, a second reaction bath provided with a cathode electrically connected with the anode and receiving an aqueous solution, the second reaction bath being separated from the first reaction bath, ferrous ions being oxidized to ferric ions in the first reaction bath to precipitate hydroxides, hydroxide ions being produced in the second reaction bath; and
a precipitation bath for receiving the acid mine drainage discharged from the first reaction bath and the aqueous solution discharged from the second reaction bath, controlling pH, and precipitating and recovering useful metals from the acid mine drainage,
the amount of the aqueous solution inflowing from the second reaction bath to the precipitation bath being controlled to control the pH of the precipitation bath.

7. The system for treating acid mine drainage of claim 6, further comprising a circulating pipe for connecting the precipitation bath and the second reaction bath for inflowing the acid mine drainage from the precipitation bath to the second reaction bath.

8. The system for treating acid mine drainage of claim 6, wherein a plurality of the precipitation baths are installed and making inter-communication one by one, and
the acid mine drainage from the first reaction bath is transported via the plurality of precipitation baths one by one, and the acid mine drainage in respective precipitation bath is formed to have a different pH range to precipitate different useful metals in each precipitation bath.

9. The system for treating acid mine drainage of claim 8, further comprising an injecting pipe for interconnecting the second reaction bath and the plurality of precipitation baths to inject the aqueous solution in the second reaction bath to the plurality of the precipitation baths, and
pH of each acid mine drainage in the plurality of the precipitation baths is formed to have a different range by controlling the amount of the aqueous solution from the second reaction bath to each of the plurality of the precipitation baths.

10. The system for treating acid mine drainage of claim 6, further comprising a pH sensor provided in the precipitation bath for measuring the pH of the acid mine drainage.

11. The system for treating acid mine drainage of claim 6, wherein a mixing part is formed in the precipitation bath so that the acid mine drainage discharged from the first reaction bath and the aqueous solution discharged from the second reaction bath inflow to the precipitation bath in a mixture state,
a supplying pipe connected with the first reaction bath and an injecting pipe connected from the second reaction bath being connected to the mixture part.

12. The system for treating acid mine drainage of claim 6, wherein a collecting part separated by a partition is formed on one side of the precipitation bath so as to receive supernatant at the upper portion of the acid mine drainage received in the precipitation bath.

13. The system for treating acid mine drainage of claim 6, further comprising an electron transport medium for blocking the transport of metal cations however for allowing the transport of electrons between the acid mine drainage received in the first reaction bath and the aqueous solution received in the second reaction bath.

14. The system for treating acid mine drainage of claim 13, wherein the electron transport medium includes a connecting pipe for connecting between the first reaction bath and the second reaction bath, and a membrane installed to block the flow path in the connecting tube and to transport only electrons.

15. The system for treating acid mine drainage of claim 14, wherein the membrane is a gore-tex material or an anionic film for selectively penetrating only electrons and anions.

16. The system for treating acid mine drainage of claim 13, wherein the electron transport medium is a salt bridge of which terminals are connected to each of the first reaction bath and the second reaction bath.

17. The system for treating acid mine drainage of claim 6, wherein inlets are formed at the bottom portions of the first reaction bath and the second reaction bath, and outlets are formed at the top portions of the first reaction bath and the second reaction bath, the acid mine drainage making a passage of inflowing from the bottom portion and draining to the top portion.
